(19) United States
(12) Patent Application Publication
(10) Pub. No.: US 2006/0164575 A1
(43) Pub. Date: Jul. 27, 2006

(54) Transflective liquid crystal display device and pixel electrode thereof

(76) Inventors: Jenn-Jia Su, Budai Township (TW); Meng-Chang Tsai, Chiayi City (TW); Ching-Huan Lin, Sinying City (TW)

Correspondence Address: RABIN & Berdo, PC, 1101 14TH STREET, NW, SUITE 500, WASHINGTON, DC, 20005, US

(21) Appl. No.: 11/202,184

(22) Filed: Aug. 12, 2005

(30) Foreign Application Priority Data
Jan. 21, 2005 (TW) 94101910

(51) Int. Cl. G02F 1/1335

(52) U.S. Cl. 349/114

(57) ABSTRACT

A pixel electrode of a transflective LCD device includes a transparent electrode and a reflective electrode formed on a lower substrate, and a first common electrode and a second common electrode, which are independently formed on an upper substrate and positioned at positions corresponding to the transparent electrode and the reflective electrode, respectively.

This application claims the benefit of Taiwan application Serial No. 94101910, filed Jan. 21, 2005, the subject matter of which is incorporated herein by reference.

### BACKGROUND OF THE INVENTION

1. Field of the Invention

The invention relates in general to a pixel electrode of a transflective liquid crystal display (LCD) device, and more particularly to a pixel electrode capable of enhancing the contrast and reflectivity of a transflective LCD device.

2. Description of the Related Art

Owing to the rapid growth in the consumption market of the portable products, such as personal digital assistants (PDAs), cellular phones, projectors and even the large-scale projection televisions, the demand on the LCDs has been getting larger and larger. Higher display qualities of the portable product or the projection television are required for more and more consumers.

The LCD may be divided into three types including transmissive, reflective and transflective types according to the reflecting way. The transmissive LCD achieves the transmissive display using a backlight light source, and has the advantage of a good display quality in the normal light and the dark light conditions. However, the transmissive display cannot clearly display the content under the outdoor daylight. The reflective LCD does not need an additional light source but uses the ambient light, so the reflective LCD has a better display quality under the outdoor light or the sufficient indoor light. Thus, the power consumption of the reflective LCD is smaller than that of the transmissive LCD. The transflective LCD combines the advantages of the transmissive and reflective LCDS, and has been used in the products such as the cellular phones or the personal digital assistants.

FIG. 1 is a schematically cross-sectional view showing a single pixel in a conventional transflective LCD device. Referring to FIG. 1, a single pixel of a conventional transflective LCD device has a transmissive region 1 and a reflective region 2, and includes an upper substrate 30, a lower substrate 20, and a liquid crystal layer 40 interposed between the upper substrate 30 and the lower substrate 20. A reflective plate 22 is formed above the lower substrate 20 at a position corresponding to the reflective region 2, and a transparent electrode 24 is formed above the reflective plate 22 at a position corresponding to the transmissive region 1 and the reflective region 2. A common electrode 32 is formed at the upper substrate 30. The orientation of the liquid crystal molecule 41 in the liquid crystal layer 40 is changed by applying a voltage difference across the transparent electrode 24 and the common electrode 32, such that the polarization direction of the light passing through the liquid crystal layer 40 is changed.

The light source of the transmissive region 1 is provided by a backlight module 26 below the lower substrate 20, as shown by the incident light 11 of FIG. 1. The light source of the reflective region 2 comes from the outside environment, as shown by the incident light 12. The light transmission rate changes with the change of the orientation of the liquid crystal molecule 41. Controlling the voltage difference applied across the transparent electrode 24 and the common electrode 32 can make the display device display the brightness with difference gray scales. However, the phase delay is caused because the optical path of the incident light 11 in the transmissive region 1 is different from that of the incident light 12 in the reflective region 2. FIG. 2 is a schematic illustration showing transmission rate curves in a transmissive region and a reflective region in the conventional transflective LCD device. The incident light 11 of the transmissive region 1 passes through the liquid crystal layer 40, directly passes through the common electrode 32 and the upper substrate 30, and then leaves. The incident light 12 of the reflective region 2 coming from the outside firstly passes through the upper substrate 30 and the liquid crystal layer 40 and arrives at the reflective plate 22. Then the incident light 12 is reflected, passes through the liquid crystal layer 40 and the upper substrate 30, and then leaves. Consequently, the phase delay of the reflected light is almost twice that of the transmitted light. Thus, the transmission rate curves in the transmissive region and the reflective region cannot overlap with each other. As shown in FIG. 2, when the voltage is 3.5, the transmissive region 1 has become a completely dark state, but the reflective region 2 has not reached the completely dark state. This will cause the poor contrast (low contrast) of the display device and reduce the reflectivity. In present, a dual gap design using different gaps in the transmissive region and the reflective region to solve the problem of the phase delay of the light has been disclosed in order to increase the optical efficiency of the liquid crystal. In addition, a scatter plate may be additionally added. However, these conventional methods increase the complexity of the manufacturing processes, reduce the yield, and increase the manufacturing cost.

### SUMMARY OF THE INVENTION

It is therefore an object of the invention to provide a transflective LCD device and its pixel electrode capable of enhancing the contrast and reflectivity of the transflective LCD device.

The invention achieves the above-identified object by providing a pixel electrode applicable to a transflective LCD device. The pixel electrode includes a transparent electrode and a reflective electrode both formed on a lower substrate, and a first common electrode and a second common electrode, which are independently formed on an upper substrate and positioned at positions corresponding to the transparent electrode and the reflective electrode, respectively.

The invention also achieves the above-identified object by providing a transflective LCD device, which includes a bottom board structure, a top board structure, and a liquid crystal layer interposed between the top board structure and the bottom board structure. The bottom board structure includes a lower substrate, a plurality of scan lines and a plurality of data lines, both of which are arranged in an array, and a plurality of thin film transistors (TFTs). The scan lines perpendicularly cross the data lines to define a plurality of pixel regions. Each of the pixel regions is defined by a pair of adjacent two of the scan lines and a pair of adjacent two of the data lines. A transparent electrode and a reflective electrode are disposed in each of the pixel regions. The transparent electrode and the reflective electrode are formed on the lower substrate. Each thin film transistors is disposed in one of the pixel regions. The top board structure includes an upper substrate, and a first common electrode and a second common electrode, both of which are independently formed on the upper substrate and opposed to the transparent electrode and the reflective electrode, respectively.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 is a schematically cross-sectional view showing a single pixel in a conventional transflective LCD device.

FIG. 2 is a schematic illustration showing transmission rate curves in a transmissive region and a reflective region in the conventional transflective LCD device.

FIG. 3 is a schematically cross-sectional view showing one single pixel of a transflective LCD device according to a preferred embodiment of the invention.

FIG. 4 is a top view showing the single pixel of the transflective LCD device according to the preferred embodiment of the invention.

FIG. 5 is a schematic illustration showing transmission rate curves in a transmissive region and a reflective region in the transflective LCD device according to the preferred embodiment of the invention.

FIGS. 6A and 6B respectively show reflective contrast viewing angles of transflective LCD devices in an electrode structure of the preferred embodiment of the invention and in a conventional electrode structure.

### DETAILED DESCRIPTION OF THE INVENTION

The invention discloses a pixel electrode applicable to a transflective LCD device, wherein the transmission rate curves in the transmissive region and the reflective region may overlap with each other such that the display contrast and the reflectivity may be enhanced. The description will be made according to a preferred embodiment of the invention. In addition, unnecessary elements are omitted in the drawing in order to illustrate the embodiment of the invention clearly.

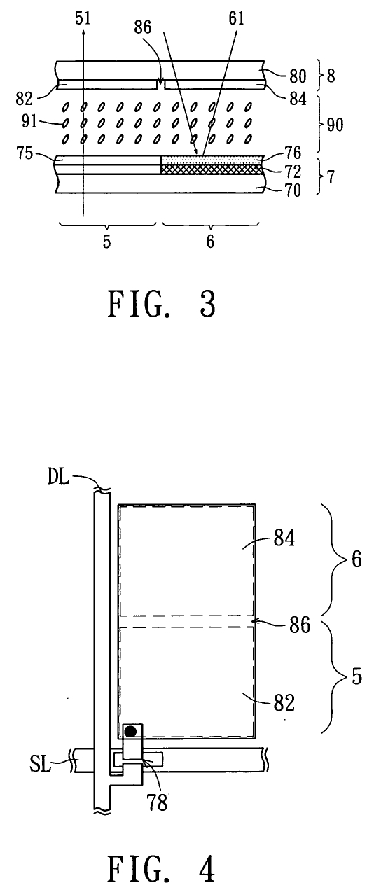

FIG. 3 is a schematically cross-sectional view showing one single pixel of a transflective LCD device according to a preferred embodiment of the invention. FIG. 4 is a top view showing the single pixel of the transflective LCD device according to the preferred embodiment of the invention. Referring to FIG. 3, the transflective LCD device includes a bottom board structure 7, a top board structure 8, and a liquid crystal layer 90 interposed between the top board structure 8 and the bottom board structure 7. The liquid crystal layer 90 has a plurality of liquid crystal molecules 91. The bottom plate structure 7 includes a lower substrate 70, a plurality of scan lines SL, a plurality of data lines DL and a plurality of TFTs. The data lines and the scan lines are arranged in an array. The scan lines perpendicularly cross the data lines to define a plurality of pixel regions. As shown in FIG. 4, each of the pixel regions is defined by a pair of adjacent two of the scan lines and a pair of adjacent two of the data lines, and a thin film transistor 78 is disposed in each pixel region.

In one single pixel of the transflective LCD device, the pixel may be divided into a transmissive region 5 and a reflective region 6 according to the optical path. As shown in FIG. 3, the lower substrate 70 of the bottom plate structure 7 has a transparent electrode 75 and a reflective electrode 76, which are positioned at positions respectively corresponding to the transmissive region 5 and the reflective region 6 in the pixel. In practice, a transparent conductive material, such as the indium tin oxide (ITO), may be used to form the transparent electrode 75 and the reflective electrode 76, and a reflective plate 72 is further disposed between the reflective electrode 76 and the lower substrate 70 in order to reflect the incident light 61 entering the reflective region 6. Alternatively, a transparent ITO and a metal aluminum layer may be directly used to form the transparent electrode 75 and the reflective electrode 76, respectively. The invention does not intend to limit this aspect of the invention.

A first common electrode 82 and a second common electrode 84 are electrically independently formed on an upper substrate 80 at positions corresponding to those of the transparent electrode 75 and the reflective electrode 76. For example, the first common electrode 82 and the second common electrode 84 are opposed to the transparent electrode 75 and the reflective electrode 76 respectively. When the display device is to be driven, different voltages are simultaneously applied to the first common electrode 82 and the second common electrode 84 such that the liquid crystal molecules 91 in the transmissive region 5 and the reflective region 6 generate different tilt angles to compensate for the phase delay between the transmissive light 51 in the transmissive region 5 and the reflected light 61 in the reflective region 6.

In this preferred embodiment, the first common electrode 82 and the second common electrode 84 are electrically independently formed by forming a spacing 86 therebetween to achieve electrical isolation. Because the arrangement of the liquid crystal molecules 91 close to the spacing 86 is disordered, and the disordered liquid crystal molecules 91 in the transmissive region 5 influence the light transparency, the spacing 86 is preferably opposed to the reflective electrode 76.

The experimental result of the transmission rate and the contrast according to the pixel electrode of the preferred embodiment of the invention may be obtained as follows.

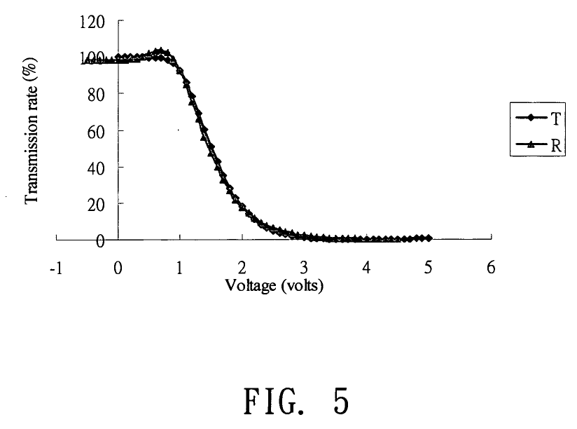

FIG. 5 is a schematic illustration showing transmission rate curves in a transmissive region and a reflective region in the transflective LCD device according to the preferred embodiment of the invention. The result of FIG. 5 is obtained by holding the first common electrode 82 in the transmissive region 5 at 0V, and the second common electrode 84 in the reflective region 6 at 0.5V. As shown in the result, the transmission rate curve (the curve formed by the rhombuses) in the transmissive region almost overlaps with the transmission rate curve (the curve formed by the triangles) in the reflective region. Consequently, using the pixel electrode of the preferred embodiment of the invention can improve the reflectivity and enhance the optical efficiency.

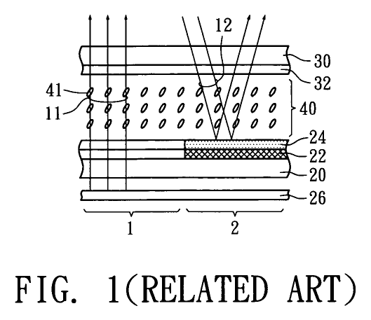

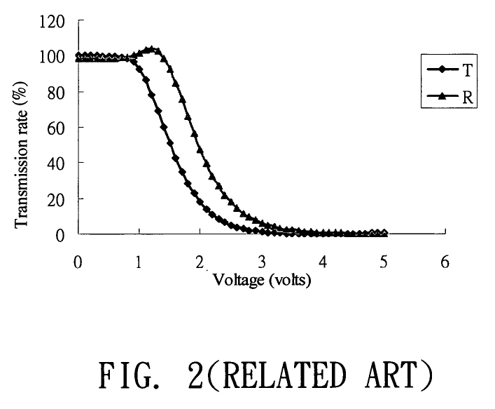

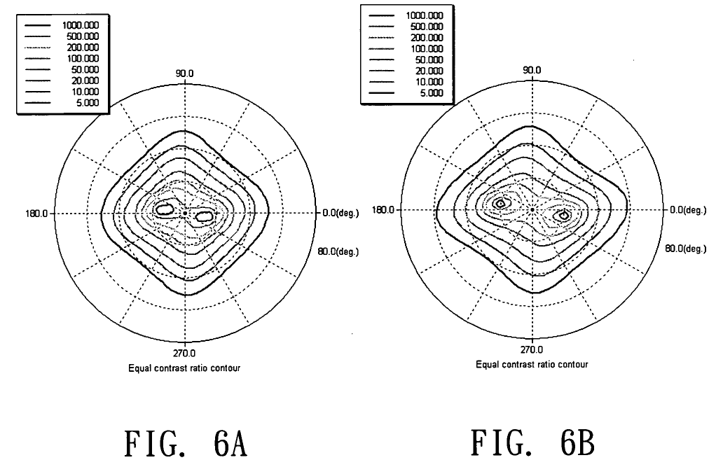

FIGS. 6A and 6B respectively show reflective contrast viewing angles of transflective LCD devices in an electrode structure of the preferred embodiment of the invention and in the conventional electrode structure. The conventional transflective LCD device has a single common electrode, as shown in FIG. 1, and the center contrast is 150. The transflective LCD device according to the preferred embodiment of the invention has two independent common electrodes, and the center contrast is 550. Compares the two contrast contour curves with each other, it is shown that the multiple common electrodes according to the preferred embodiment of the invention can really improve the maximum contrast and the center contrast.

When the pixel electrode of the disclosed embodiment is applied to the transflective LCD device, the contrast and reflectivity of the transflective LCD device can be enhanced, and the multiple independent common electrodes may be easily formed without the complicated processes. So, compared to the conventional method for manufacturing the dual gaps, the invention can increase the yield and reduce the manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pixel electrode applicable to a transflective liquid crystal display (LCD), comprising:
a transparent electrode and a reflective electrode both formed on a lower substrate; and
a first common electrode and a second common electrode, which are independently formed on an upper substrate and positioned at positions corresponding to the transparent electrode and the reflective electrode, respectively.

2. The pixel electrode according to claim 1, wherein each of the first common electrode and the second common electrode is an indium tin oxide (ITO).

3. The pixel electrode according to claim 1, wherein the transparent electrode is made of ITO, and the reflective electrode is made of aluminum.

4. The pixel electrode according to claim 1, wherein a spacing exists between the first common electrode and the second common electrode.

5. The pixel electrode according to claim 4, wherein the spacing is opposed to the reflective electrode.

6. A transflective LCD device, comprising:
a bottom board structure, which comprises
a lower substrate;
a plurality of scan lines and a plurality of data lines, both of which are arranged in an array, wherein the scan lines perpendicularly cross the data lines to define a plurality of pixel regions, each of the pixel region is defined by a pair of adjacent two of the scan lines and a pair of adjacent two of the data lines, a transparent electrode and a reflective electrode are disposed in each of the pixel regions, and the transparent electrode and the reflective electrode are formed on the lower substrate; and
a plurality of thin film transistors (TFTs), each thin film transistor being disposed in one of the pixel regions;
a top board structure, which comprises
an upper substrate; and
a first common electrode and a second common electrode, which are independently formed on the upper substrate and opposed to the transparent electrode and the reflective electrode, respectively; and
a liquid crystal layer interposed between the top board structure and the bottom board structure.

7. The LCD device according to claim 6, wherein both of the first common electrode and the second common electrode are ITOs.

8. The LCD device according to claim 6, wherein the transparent electrode is made of ITO, and the reflective electrode is made of aluminum.

9. The LCD device according to claim 6, wherein different voltages are applied to the first common electrode and the second common electrode to drive the LCD device.

10. The LCD device according to claim 6, wherein a spacing exists between the first common electrode and the second common electrode.

11. The LCD device according to claim 10, wherein the spacing is opposed to the reflective electrode.
